(19) United States
(12) Patent Application Publication
(10) Pub. No.: US 2024/0275665 A1
(43) Pub. Date: Aug. 15, 2024

(54) NETWORK MANAGEMENT APPARATUS, METHOD, AND PROGRAM

(71) Applicant: NIPPON TELEGRAPH AND TELEPHONE CORPORATION, Tokyo (JP)

(72) Inventors: Hiroaki MATSUBAYASHI, Musashino-shi, Tokyo (JP); Masataka SATO, Musashino-shi, Tokyo (JP); Kenji MURASE, Musashino-shi, Tokyo (JP); Shunsuke KANAI, Musashino-shi, Tokyo (JP); Kazuaki AKASHI, Musashino-shi, Tokyo (JP); Manami OGAWA, Musashino-shi, Tokyo (JP)

(73) Assignee: NIPPON TELEGRAPH AND TELEPHONE CORPORATION, Tokyo (JP)

(21) Appl. No.: 18/567,378

(22) PCT Filed: Jun. 7, 2021
(86) PCT No.: PCT/JP2021/021537

§ 371 Date: Dec. 6, 2023

(51) Int. Cl. H04L 41/0663

(52) U.S. Cl. CPC H04L 41/0663

(57) ABSTRACT

A network management apparatus including a failure influence calculation unit that calculates, in a case where a communication failure occurs in a plurality of buildings in which communication facilities are accommodated and which correspond to upper layers of a network, an influence of the communication failure, the influence being an influence on other buildings corresponding to lower layers of the network by the occurred failure. Further, there is a priority calculation unit that calculates a priority of a possibility of the buildings in which the occurred failure is to be actually recovered among the buildings in which the failure occurs and which correspond to the upper layers, based on a degree of the communication failure continuously occurring in any building of the network under a condition in which the occurred failure and the influence calculated by the failure influence calculation unit are applied.

### TECHNICAL FIELD

An embodiment of the present invention relates to a network management apparatus, a network management method, and a network management program.

### BACKGROUND ART

In a building (sometimes referred to as a communication building) in which communication facilities are accommodated and which provides communication with the outside, in a case where communication in the building is disconnected by stopping of supply of power from a power plant due to an occurrence of a disaster such as an earthquake or a typhoon, provision of communication is restarted by operating an emergency power generator or the like that is provided in the building and is operated by fuel and recovering supply of power related to the communication facilities.

In a case where the emergency power generator operates for a long time and the fuel stored in the building is exhausted, the operation of the emergency power generator is stopped. As a result, supply of power is stopped again and communication is disconnected. For this reason, a communication provider delivers and supplies fuel to the communication building by a vehicle or the like.

A communication provider needs to prevent communication disconnection and restart provision of communication at an early stage by delivering fuel in advance to a communication building before fuel is exhausted by a fuel delivery vehicle or by promptly delivering fuel to a communication building in which fuel is exhausted by a fuel delivery vehicle.

Under a condition of limited fuel resources, in order to minimize an influence of communication disconnection, a communication provider needs to select a repair target building (sometimes referred to as a building to be repaired), which is a fuel delivery destination, in a short time from a large number of communication buildings in which fuel is exhausted among the communication buildings in which supply of power is stopped.

The building to be repaired needs to be selected according to various situations such as the disaster-stricken building, an influence on a communication network service that is extended from a building, a location of the building, a fuel situation of the building, and a traffic situation, and a lot of time and advanced skills are required for examination by a person.

Since responding to a disaster requires urgency and a frequency of occurrence of a disaster is low, it is difficult to train skilled persons. Therefore, there is a need for a technique of selecting a building to be repaired in view of situations when a disaster occurs and automatically determining a fuel delivery plan for the building in a short time.

For example, Patent Literature 1 discloses a technique in which network configuration information and failure influence information are required. In the technique, a building to be preferentially repaired among buildings is evaluated based on the failure influence information, and the delivery plan can be determined.

### CITATION LIST

### Patent Literature

Patent Literature 1: JP 2020-65202 A

### SUMMARY OF INVENTION

### Technical Problem

However, in the technique, a communication network redundant configuration is not considered, and as a result, an appropriate priority for each building as a failure recovery target is not calculated.

The present invention has been made in view of the above circumstances, and an object of the present invention is to provide a network management apparatus, a network management method, and a network management program capable of appropriately determining a failure recovery target in a case where a communication failure occurs in a network redundant configuration.

### Solution to Problem

According to an aspect of the present invention, there is provided a network management apparatus including: a failure influence calculation unit that calculates, in a case where a communication failure occurs in a plurality of buildings in which communication facilities are accommodated and which correspond to upper layers of a network, an influence of the communication failure, the influence being an influence on other buildings corresponding to lower layers of the network by the occurred failure; and a priority calculation unit that calculates a priority of a possibility of the buildings in which the occurred failure is to be actually recovered among the buildings in which the failure occurs and which correspond to the upper layers, based on a degree of the communication failure continuously occurring in any building of the network under a condition in which the occurred failure and the influence calculated by the failure influence calculation unit are applied and in a case where a condition in which it is assumed that the occurred failure is recovered in the buildings by recovery work for the communication facilities accommodated in the buildings in which the failure occurs and which correspond to the upper layers is applied.

According to another aspect of the present invention, there is provided a network management method including: calculating, in a case where a communication failure occurs in a plurality of buildings in which communication facilities are accommodated and which correspond to upper layers of a network, an influence of the communication failure, the influence being an influence on other buildings corresponding to lower layers of the network by the occurred failure; and calculating a priority of a possibility of the buildings in which the occurred failure is to be actually recovered among the buildings in which the failure occurs and which correspond to the upper layers, based on a degree of the communication failure continuously occurring in any building of the network under a condition in which the occurred failure and the calculated influence are applied and in a case where a condition in which it is assumed that the occurred failure is recovered in the buildings by recovery work for the communication facilities accommodated in the buildings in which the failure occurs and which correspond to the upper layers is applied.

### Advantageous Effects of Invention

According to the present invention, in a case where a communication failure occurs in a network redundant configuration, it is possible to appropriately calculate an influence of the failure.

### BRIEF DESCRIPTION OF DRAWINGS

FIG. 1 is a diagram illustrating an application example of a network management apparatus according to an embodiment of the present invention.

FIG. 2 is a flowchart illustrating an example of a processing procedure by the network management apparatus according to the embodiment of the present invention.

FIG. 3 is a diagram illustrating an example of functions of a priority calculation unit and a deployment plan processing unit.

FIG. 4 is a diagram illustrating an example of buildings which are included in a network redundant configuration and in which communication facilities are accommodated.

FIG. 5 is a diagram illustrating an example of an influence in a case where recovery related to a single building in which a communication failure occurs is performed.

FIG. 6 is a diagram illustrating an example of an influence in a case where recovery related to buildings in which communication failures occur is performed.

FIG. 7 is a diagram illustrating a first example of the number of influenced users calculated for each combination of buildings to be repaired by the priority calculation unit according to the embodiment of the present invention.

FIG. 8 is a diagram illustrating a second example of the number of influenced users calculated for each combination of buildings to be repaired by the priority calculation unit according to the embodiment of the present invention.

FIG. 9 is a diagram illustrating a third example of the number of influenced users calculated for each combination of buildings to be repaired by the priority calculation unit according to the embodiment of the present invention.

FIG. 10 is a diagram illustrating a fourth example of the number of influenced users calculated for each combination of buildings to be repaired by the priority calculation unit according to the embodiment of the present invention.

FIG. 11 is a diagram illustrating a fifth example of the number of influenced users calculated for each combination of buildings to be repaired by the priority calculation unit according to the embodiment of the present invention.

FIG. 12 is a diagram illustrating an example of generation of a deployment plan of recovery work vehicles that is for recovery of buildings to be repaired and is obtained by the deployment plan processing unit according to the embodiment of the present invention.

FIG. 13 is a diagram illustrating an example of a determination result as to whether or not a recovery work vehicle can be deployed by the deployment plan processing unit according to the embodiment of the present invention.

FIG. 14 is a block diagram illustrating an example of a hardware configuration of the network management apparatus according to the embodiment of the present invention.

### DESCRIPTION OF EMBODIMENTS

Hereinafter, an embodiment according to the present invention will be described with reference to the drawings.

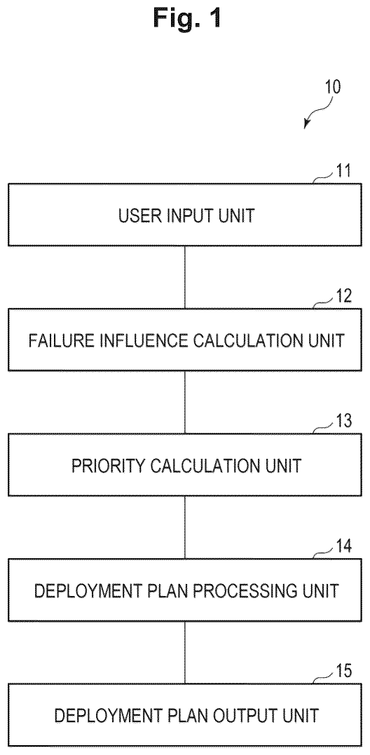

FIG. 1 is a diagram illustrating an application example of a network management apparatus according to an embodiment of the present invention.

As illustrated in FIG. 1, a network management apparatus 10 according to an embodiment of the present invention includes a user input unit 11, a failure influence calculation unit 12, a priority calculation unit 13, a deployment plan processing unit 14, and a deployment plan output unit 15.

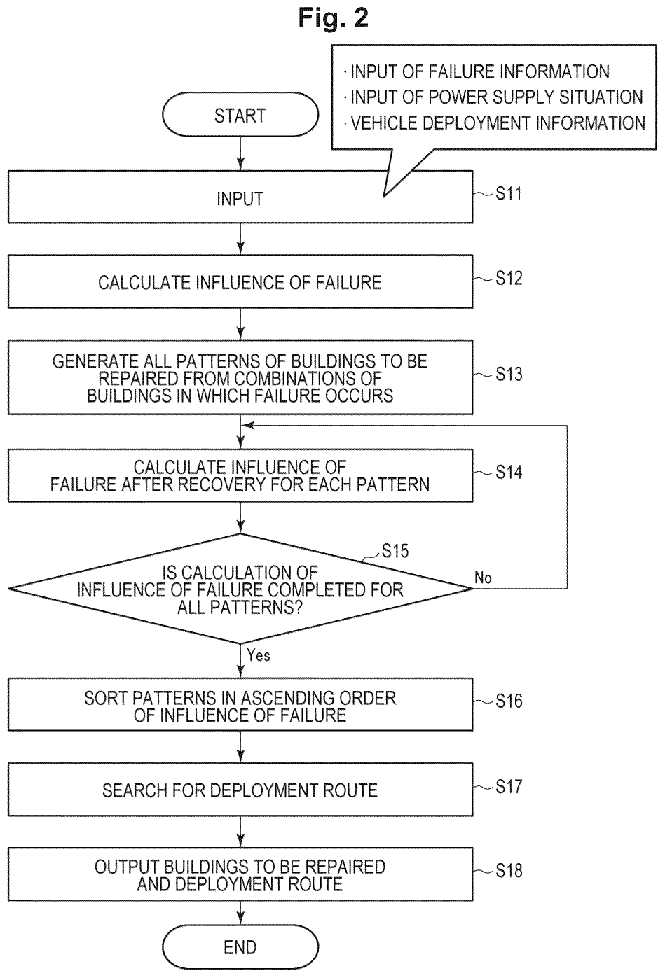

FIG. 2 is a flowchart illustrating an example of a processing procedure by the network management apparatus according to the embodiment of the present invention.

The user input unit 11 inputs failure information indicating a communication failure occurring in any of a plurality of buildings that are buildings in which communication facilities are accommodated and which are included in a network redundant configuration, a power (electricity) supply status related to recovery of the occurred communication failure, and vehicle deployment information related to a recovery work vehicle deployed for recovery of the communication failure (S11).

The power supply situation is, for example, an amount of a fuel that needs to be replenished to an emergency power generator to be described which is accommodated in each building, an elapsed time from occurrence of a communication failure in each building, and the like. In addition, the vehicle deployment information is, for example, a current position of the recovery work vehicle, the number of recovery work vehicles that can move to the building, an amount of a fuel that can be transported and supplied by each recovery work vehicle, and the like.

The failure influence calculation unit 12 calculates, based on the failure information which is input in S11, an influence of the communication failure that indicates an influence on other buildings in the same network configuration due to a communication failure occurred by stopping of supply of power to the communication facilities accommodated in some buildings in the network configuration (S12).

Under a condition that a failure indicated by the failure information which is input in S11 and a calculation result in S12 are applied, the priority calculation unit 13 generates all patterns of combinations of buildings to be repaired, that is, buildings to be recovered from the communication failure, from combinations of buildings in which a communication failure occurs (S13).

The priority calculation unit 13 calculates, for each of the generated patterns, a value indicating degrees of the communication failure and the influence of the communication failure continuously occurring in any building in a case where a condition in which it is assumed that repair to the building according to the pattern is performed, for example, supply of power to the communication facility accommodated in the building is recovered is applied (S14).

In a case where the calculation in S14 is not completed for all the patterns (No in S15), processing in S14 is performed for another pattern.

In addition, in a case where the calculation in S14 is completed for all the patterns (Yes in S15), the priority calculation unit 13 generates information obtained by sorting each pattern in ascending order of the value indicating the degrees of the communication failure and the influence of the communication failure among the patterns of the buildings in which the failure occurs such that a priority of a building possibility to be actually recovered from the occurred failure is set to be high (S16).

The deployment plan processing unit 14 assigns a priority to a pattern to which a high priority is set among the sorted patterns, and searches for a recovery work vehicle and an appropriate deployment route of the vehicle for each building of the pattern according to the priority based on the power supply situation and the vehicle deployment information which are input in S11 (S17).

In response to a search result in S17, the deployment plan output unit 15 outputs a name of the building to be repaired and information indicating a deployment route of the recovery work vehicle to the corresponding building, that is, a movement route of the recovery work vehicle (S18).

Details of each processing will be described below.

The user input unit 11 inputs, by an input operation or the like by an operator or the like, a connection relationship of each building in the network redundant configuration, a type of an emergency power supply in each building, a location of each building, information indicating an influence degree in a case where a communication failure occurs in the building, an elapsed time from the occurrence of the communication failure in the building, and the like, which are related to each building included in the redundant configuration of the communication network in which communication is provided.

The provision of communication in the building means, for example, communication between communication devices in the building and communication between a communication device in the building and an external communication device.

Examples of the communication failure include communication disconnection due to stopping of supply of power to communication facilities in the building, or communication disconnection due to a failure of a communication device such as a server, communication disconnection due to damage to a communication cable, and the like. In the following description of the present embodiment, communication disconnection due to stopping of supply of power to communication facilities in the building will be described as an example.

Examples of the type of the emergency power supply in each building include an emergency power generator operated by fuel and an emergency power supply device operated by a storage battery that can be charged and discharged. The emergency power generator is, for example, a diesel engine.

The building may be a structure having another form as long as the structure includes a facility that provides communication.

The connection relationship of each building may include, for example, information indicating an upper layer (simply referred to as upper in some cases) and a lower layer (simply referred to as lower in some cases) in a network topology. Examples of the influence degree at the time of occurrence of the communication failure include the number of users who can be accommodated in the building in which the communication failure occurs and use communication (sometimes referred to as accommodatable users), the number of communication devices provided in the building, an amount of data transmitted and received by the communication devices provided in the building, and the like.

In addition, the user input unit 11 inputs, by an input operation or the like, information related to the vehicles (hereinafter, sometimes referred to as recovery work vehicles) used for the communication recovery work for the building in which the communication failure occurs, such as the number of the vehicles, types of the vehicles, position information of each vehicle, an amount of fuel or the like that can be supplied for the emergency power generator by each vehicle, a traffic condition of a traveling area of each vehicle, and the like. Examples of the traffic condition include information indicating a traffic volume in the traveling area, information indicating whether a road is passable due to construction or a disaster, and the like.

Examples of the types of the vehicles include a fuel delivery vehicle and a power supply vehicle.

The fuel delivery vehicle is a vehicle including a facility that loads fuel for the emergency power generator and supplies the fuel to the emergency power generator in a case where the emergency power supply in the building is the emergency power generator.

In addition, in a case where the emergency power supply in the building is the emergency power supply device, the power supply vehicle is a vehicle including a charging device for charging the storage battery, or a vehicle including a replacement storage battery in a case where the storage battery is replaceable, that is, a vehicle including a new charged storage battery.

The failure influence calculation unit 12 specifies, based on the information input by the user input unit 11, among the buildings in the network redundancy configuration, a plurality of lower buildings in the network topology in which communication is disconnected due to the influence of the communication failure that occurs in a plurality of upper buildings in the network topology.

A technique of specifying a facility in which communication is disconnected due to the influence of the communication failure is, for example, a known technique disclosed in Patent Literature 1.

In addition, the failure influence calculation unit 12 calculates an influence degree at the time of occurrence of the communication failure under a condition in which it is assumed that the failure is recovered in some or all of the buildings in which the failure occurs, for example, the number of accommodatable users of the lower buildings that are continuously influenced by the failure under a condition in which it is assumed that the recovery is performed in some or all of the buildings in which the failure occurs.

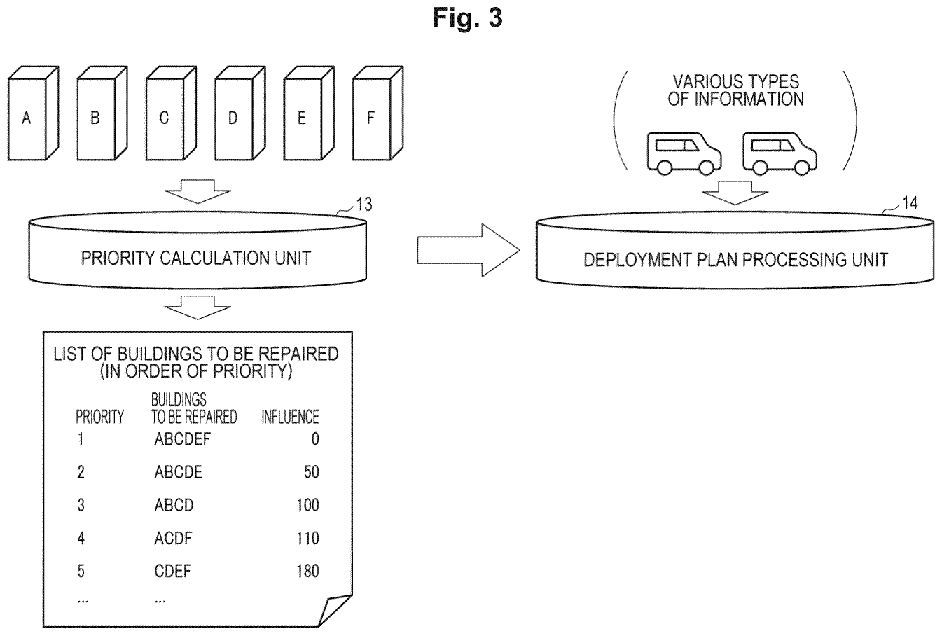

FIG. 3 is a diagram illustrating an example of functions of the priority calculation unit and the deployment plan processing unit.

The priority calculation unit 13 calculates a priority related to the recovery of the communication failure for each of the patterns of the combinations including some or all of the plurality of specified buildings, based on a level of the calculated influence degree at the time of occurrence of the communication failure.

In the example illustrated in FIG. 3, the buildings in which the communication failure occurs are “building A”, “building B”, “building C”, “building D”, “building E”, and “building F”.

In these buildings, in a case where it is assumed that the communication failure recovery work of each building is performed and the communication failure is recovered, each building belonging to the combinations of the buildings in which the communication failure is to be recovered, the buildings in which a communication failure continuously occurs and the total number of accommodatable users of the buildings are, for example, “building A, building B, building C, building D, building E, building F: 0 person”, “building A, building B, building C, building D, building E: 50 persons”, “building A, building B, building C, building D: 100 persons”, “building A, building C, building D, building F: 110 persons”, or “building C, building D, building E, building F: 180 persons”.

Among the combinations, a combination having a small number of accommodatable users is a combination having a high effect of work related to recovery, and thus, has a high priority related to execution of work related to recovery.

The deployment plan processing unit 14 determines, based on locations of the buildings, traffic situations, and the like, whether or not the recovery work vehicle can be deployed according to the priority, in descending order of the priority calculated by the priority calculation unit 13, for each of the patterns of the combinations of the buildings included in the network redundant configuration, the recovery work vehicle being a vehicle to be sent to each building belonging to the patterns of the combinations of the buildings for recovery work of the communication failure. Based on a result of the determination, the deployment plan processing unit 14 generates deployment plan information which is information indicating the recovery work vehicle to be actually sent to the building for recovery work, a traveling schedule, a traveling route, and the like of the recovery work vehicle.

The deployment plan output unit 15 outputs the deployment plan information generated by the deployment plan processing unit 14 by displaying the deployment plan information on a display device (not illustrated) or the like.

In the present embodiment, the deployment plan of the recovery work vehicles is generated for each of the patterns of the combinations of the buildings included in the network redundant configuration among buildings in which the communication failure occurs, rather than for a single building in which the communication failure occurs. Thereby, an appropriate deployment plan of the recovery work vehicles is generated.

Therefore, for example, it is possible to automatically and quickly determine the deployment plan capable of greatly reducing a time during which the communication failure occurs in the building to be recovered from the communication failure. Thus, it is possible to eliminate a need for high-level skills related to deployment planning, and greatly reduce a time required for planning.

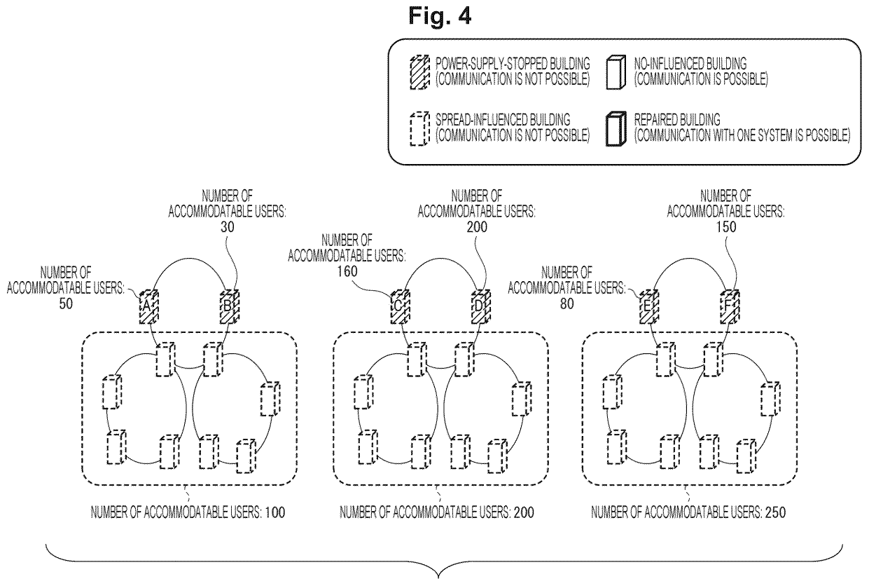

FIG. 4 is a diagram illustrating an example of buildings which are included in a network redundant configuration and in which communication facilities are accommodated.

In the example illustrated in FIG. 4, a network redundant configuration to which the network management apparatus according to the present embodiment can be applied is formed, and buildings in which communication facilities are accommodated are a group of buildings included in a ring-type communication network to which communication facilities of the buildings can be communicably connected.

In the example illustrated in FIG. 4, a building A and a building B included in a part of a group of buildings connected in a ring shape are provided as upper buildings in the network topology.

### (Building A, Building B, and Lower Buildings)

In addition, in the ring-shaped configuration, a first building closer to the building A and a second building closer to the building B are provided between the building A and the building B, and these four buildings form a first ring-shaped building group.

Further, four buildings including the first building and the other three buildings are provided as a second ring-shaped building group different from the first ring-shaped building group, and four buildings including the second building and the other three buildings are provided as a third ring-shaped building group different from the first ring-shaped building group and the second ring-shaped building group. That is, the first building is related to the first ring-shaped building group and the second ring-shaped building group, and the second building is related to the first ring-shaped building group and the third ring-shaped building group.

Among these buildings, the total eight buildings other than the building A and the building B are provided as a lower building group in the network topology, and the building A, the building B, and the lower buildings form an independent network configuration. These lower building groups may be referred to as lower buildings of the buildings A and B.

The number of users (sometimes referred to as accommodatable users) that can be accommodated in the building A is 50 persons, the number of users that can be accommodated in the building B is 30 persons, and the total number of users that can be accommodated in the lower buildings of the buildings A and B is 100 persons.

### (Building C, Building D, and Lower Buildings)

In addition, in the example illustrated in FIG. 4, the building C and the building D included in a part of a building group that is connected in a ring shape are provided as upper buildings in the network topology. As lower buildings of the building C and the building D in the network topology, lower building groups having the same configuration as the lower buildings of the buildings A and B are provided, and the building C, the building D, and the lower buildings form an independent network configuration. These lower building groups may be referred to as lower buildings of the buildings C and D.

The number of users that can be accommodated in the building C is 160 persons, the number of users that can be accommodated in the building D is 200 persons, and the total number of users that can be accommodated in the lower buildings of the buildings C and D is 200 persons.

### (Building E, Building F, and Lower Buildings)

Further, in the example illustrated in FIG. 4, the building E and the building F included in a part of a building group that is connected in a ring shape are provided as upper buildings in the network topology. As lower buildings of the building E and the building F in the network topology, lower building groups having the same configuration as the lower buildings of the buildings A and B are provided, and the building E, the building F, and the lower buildings form an independent network configuration. These lower building groups may be referred to as lower buildings of the buildings E and F.

The number of users that can be accommodated in the building E is 80 persons, the number of users that can be accommodated in the building F is 150 persons, and the total number of users that can be accommodated in the lower buildings of the buildings E and F is 250 persons.

In addition, in the example illustrated in FIG. 4, in the total six buildings including the upper buildings A to F, supply of power to the communication facilities is stopped due to a loss of power, and communication functions by the communication facilities accommodated in these buildings are stopped.

In addition, the lower buildings of the buildings A and B, the lower buildings of the buildings C and D, and the lower buildings of the buildings E and F, which are the lower buildings in the network topology when viewed from the upper buildings A to F, are in a state where supply of power to the communication facilities in the own buildings is not stopped and normal communication by the communication facilities accommodated in these buildings is disabled due to an influence of the stopping of the communication functions of the upper buildings.

In addition, in the upper buildings A to F, the priority related to repair, that is, the priority related to recovery of the communication functions is higher as an influence on the users accommodated in the building is larger.

Therefore, in the present embodiment, in a case where it is assumed that recovery of the communication failure related to some buildings of the upper buildings is performed, the number of users accommodated in the buildings in which the communication function is continuously stopped, that is, the number of users who are continuously influenced by the stopping of the communication function after the repair (sometimes referred to as the number of influenced users) is defined as the influence degree. In addition, as a value of the influence degree is smaller, an effect of the repair is higher. Therefore, in the present embodiment, as the value of the influence degree is smaller, the priority related to building repair is set to be higher.

Next, calculation of the recovery priority based on an influence in a case where recovery related to a single building in which a communication failure occurs is performed will be described.

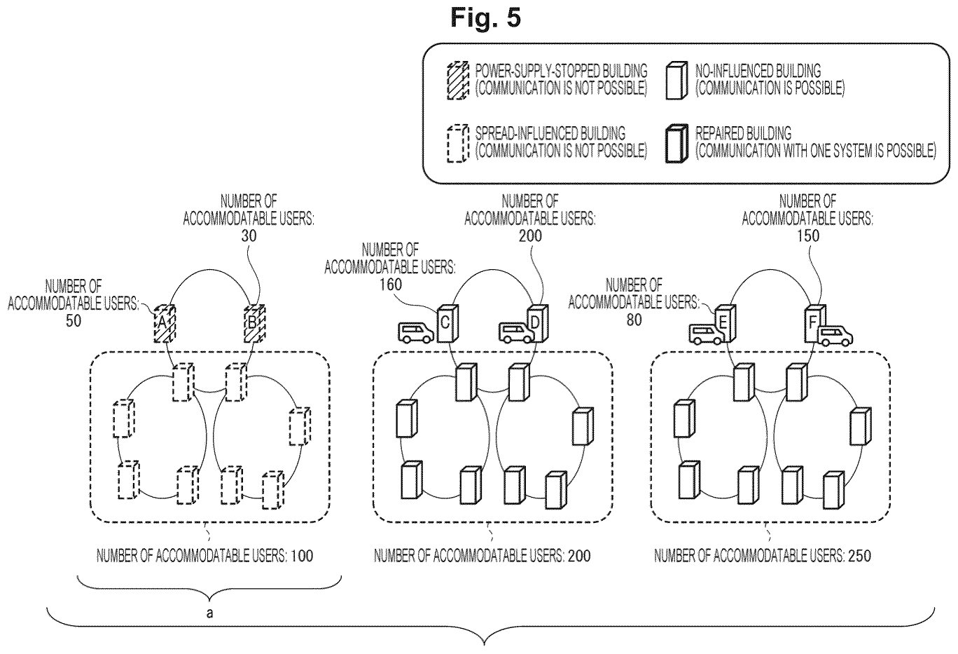

FIG. 5 is a diagram illustrating an example of an influence in a case where recovery related to a single building in which a communication failure occurs is performed. The number of accommodatable users of each building in the configuration illustrated in FIG. 5 is the number of persons described in FIG. 4.

### (Repair of Only Building A)

It is assumed that only the building A is repaired in a case where a communication failure occurs in the building A and the building B among the building A, the building B, and the lower buildings of the buildings A and B illustrated in FIG. 5. The communication failures of the lower buildings of the buildings A and B are recovered by the repair. Thus, the priority calculation unit 13 calculates that the number of users who are continuously influenced by the communication failure (sometimes referred to as the number of spread-influenced users) in the building A, the building B, and the lower buildings of the buildings A and B is the number of accommodatable users of the building B that is not repaired, that is, 30 persons.

### (Repair of Only Building B)

It is assumed that only the building B is repaired in a case where a communication failure occurs in the building A and the building B among the building A, the building B, and the lower buildings of the buildings A and B illustrated in FIG. 5.

The communication failures of the lower buildings of the buildings A and B are recovered by the repair. Thus, the priority calculation unit 13 calculates that the number of users who are continuously influenced by the communication failure among the number of accommodatable users of the building A, the building B, and the lower buildings of the buildings A and B is the number of accommodatable users of the building A that is not repaired, that is, 50 persons.

### (Repair of Only Building C)

It is assumed that only the building C is repaired in a case where a communication failure occurs in the building C and the building D among the building C, the building D, and the lower buildings of the buildings C and D illustrated in FIG. 5.

The communication failures of the lower buildings of the buildings C and D are recovered by the repair. Thus, the priority calculation unit 13 calculates that the number of users who are continuously influenced by the communication failure among the number of accommodatable users of the building C, the building D, and the lower buildings of the buildings C and D is the number of accommodatable users of the building D that is not repaired, that is, 200 persons.

### (Repair of Only Building D)

It is assumed that only the building D is repaired in a case where a communication failure occurs in the building C and the building D among the building C, the building D, and the lower buildings of the buildings C and D illustrated in FIG. 5.

The communication failures of the lower buildings of the buildings C and D are recovered by the repair. Thus, the priority calculation unit 13 calculates that the number of users who are continuously influenced by the communication failure among the number of accommodatable users of the building C, the building D, and the lower buildings of the buildings C and D is the number of accommodatable users of the building C that is not repaired, that is, 160 persons.

### (Repair of Only Building E)

It is assumed that only the building E is repaired in a case where a communication failure occurs in the building E and the building F among the building E, the building F, and the lower buildings of the buildings E and F illustrated in FIG. 5.

The communication failures of the lower buildings of the buildings E and F are recovered by the repair. Thus, the priority calculation unit 13 calculates that the number of users who are continuously influenced by the communication failure among the number of accommodatable users of the building E, the building F, and the lower buildings of the buildings E and F is the number of accommodatable users of the building F that is not repaired, that is, 150 persons.

### (Repair of Only Building F)

It is assumed that only the building F is repaired in a case where a communication failure occurs in the building E and the building F among the building E, the building F, and the lower buildings of the buildings E and F illustrated in FIG. 5.

The communication failures of the lower buildings of the buildings E and F are recovered by the repair. Thus, the priority calculation unit 13 calculates that the number of users who are continuously influenced by the communication failure among the number of accommodatable users of the building E, the building F, and the lower buildings of the buildings E and F is the number of accommodatable users of the building E that is not repaired, that is, 80 persons.

### (Calculation of Priority)

In the calculation result, the number of influenced users is large in order of (1) a case where repair of only building C is performed, (2) a case where repair of only building D is performed, (3) a case where repair of only building E is performed, (4) a case where repair of only building F is performed, (5) a case where repair of only building B is performed, and (6) a case where repair of only building A is performed. That is, the number of influenced users is largest in a case where repair of only building C is performed, and is smallest in a case where repair of only building A is performed.

Thereby, the priority calculation unit 13 calculates that the building C has a first recovery priority, that the building D has a second recovery priority, that the building E has a third recovery priority, that the building F has a fourth recovery priority, that the building B has a fifth recovery priority, and that the building A has a sixth recovery priority.

(Number of Spread-Influenced Users in a Case where Plurality of Buildings are Repaired)

In addition, it is assumed that the recovery work vehicles are sent to the buildings C, D, E, and F having the first recovery priority to the fourth recovery priority and repair of the buildings is performed. The communication failures in the lower buildings of the buildings C and D and the communication failures in the lower buildings of the buildings E and F are recovered by the repair. Thus, the number of users who are continuously influenced by the communication failures in the buildings A to F and the lower buildings is a sum of the number of accommodatable users of the unrepaired building A, the number of accommodatable users of the unrepaired building B, and the number of accommodatable users of the lower buildings of the buildings A and B, that is, 180 persons.

That is, the building A, the building B, and the lower buildings of the buildings A and B indicated by a reference sign a in FIG. 5 are not repaired, and thus the influence of the communication failures is continuously widespread.

Next, calculation of the recovery priority based on an influence in a case where recovery related to buildings in which communication failures occur is performed will be described.

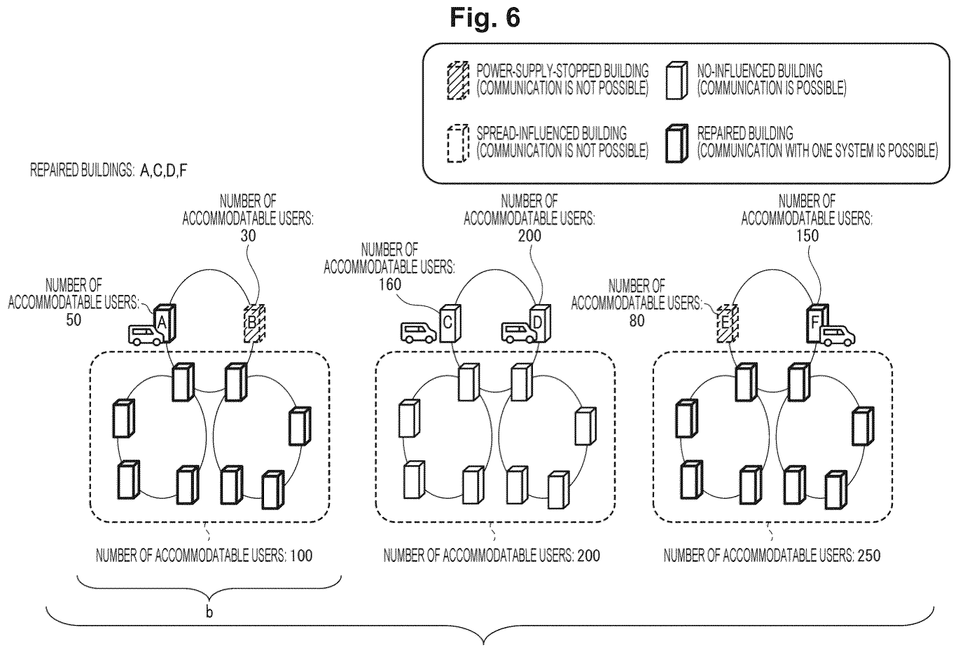

FIG. 6 is a diagram illustrating an example of an influence in a case where recovery related to buildings in which communication failures occur is performed. The number of accommodatable users of each building in the configuration illustrated in FIG. 6 is the number of persons described in FIG. 4.

Here, it is assumed that, in a case where communication failures occur in the six buildings including the upper buildings A to F illustrated in FIG. 6, the building A, the building C, the building D, and the building F are repaired by deploying a fuel delivery vehicle to each of these buildings and supplying fuel to emergency power generators accommodated in these buildings.

Since the communication failures of the building A, the building C, the building D, and the building F are recovered by the repair, as indicated by a reference sign b in FIG. 6, after the repair, the lower buildings of the buildings A and B are not influenced by the communication failures of the upper buildings, and the communication failures of the lower buildings of the buildings A and B, the communication failures of the lower buildings of the buildings C and D, and the communication failures of the lower buildings of the buildings E and F, that is, the communication failures of all the lower building groups are recovered.

Therefore, the priority calculation unit 13 calculates that the number of users who are continuously influenced by the communication failures among the number of accommodatable users of the upper buildings A to F and the lower building groups is a sum of the number of accommodatable users of the unrepaired building B and the number of accommodatable users of the unrepaired building E, that is, 110 persons.

The calculated number of persons is smaller than the finally-calculated number of persons in the example in FIG. 5, and thus it means that the building A, the building C, the building D, and the building F are appropriate as a combination of buildings to be repaired.

In the example illustrated in FIG. 5, the building E is repaired as a building having a high priority, while the building A is not repaired as a building having a low priority. On the other hand, in the example illustrated in FIG. 6, the network topology is considered, and the building A, which is not repaired as a building having a low priority in the description related to FIG. 5, is repaired. Therefore, the influence on the lower buildings of the buildings A and B is prevented, and thus it is possible to reduce the number of influenced users after the repair as compared with the example illustrated in FIG. 5.

Next, the number of influenced users calculated for each combination of buildings to be repaired by the priority calculation unit 13 according to the embodiment of the present invention will be described.

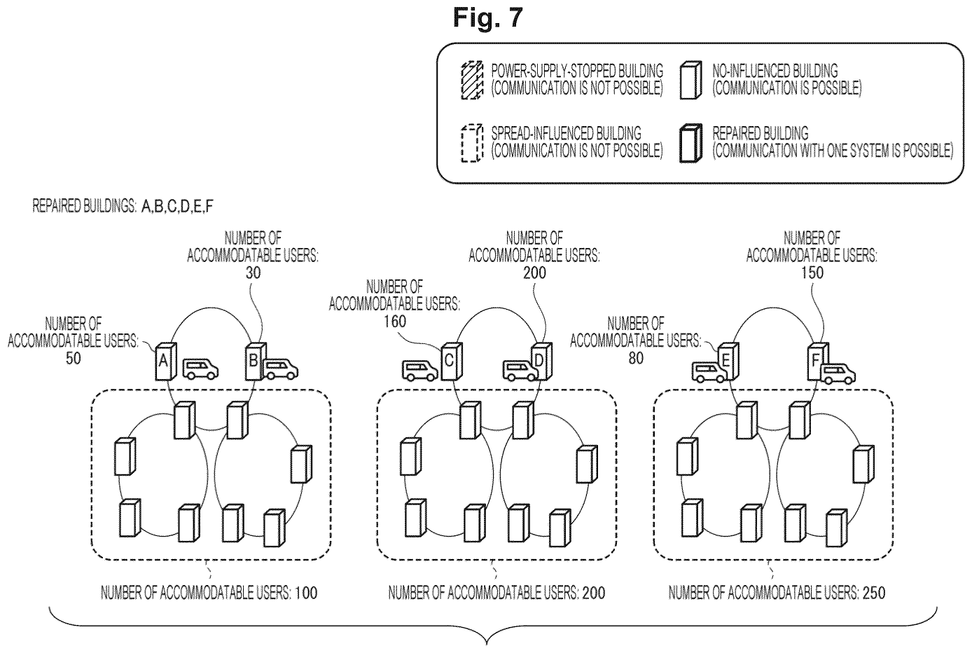

FIG. 7 is a diagram illustrating a first example of the number of influenced users calculated for each combination of buildings to be repaired by the priority calculation unit according to the embodiment of the present invention.

Here, it is assumed that each building is repaired by deploying fuel delivery vehicles to all the upper buildings, illustrated in FIG. 4, in which communication failures occur and supplying fuel to emergency power generators accommodated in these buildings.

In a case where repair to the upper buildings A to F in which the communication failures occur is performed, as illustrated in FIG. 7, the communication failures of the upper buildings A to F, the communication failures of the lower buildings of the buildings A and B, the communication failures of the lower buildings of the buildings C and D, and the communication failures of the lower buildings of the buildings E and F, that is, the communication failures of all the lower building groups are recovered. Thus, as illustrated in FIG. 7, the priority calculation unit 13 of the network management apparatus 10 according to the present embodiment calculates that communication is possible for all the buildings.

Thereby, the priority calculation unit 13 calculates that the number of influenced users, which is the number of users who are continuously influenced by the communication failures in a case where it is assumed that repair to the buildings A to F is performed, is 0 person.

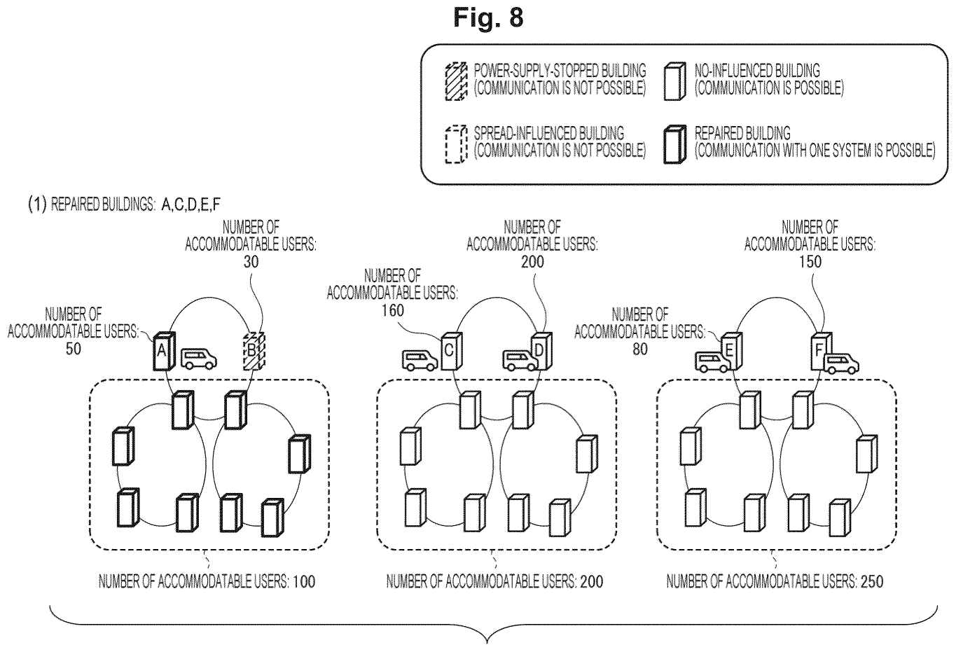

FIG. 8 is a diagram illustrating a second example of the number of influenced users calculated for each combination of buildings to be repaired by the priority calculation unit according to the embodiment of the present invention.

Here, it is assumed that each building is repaired by deploying the fuel delivery vehicles to total five buildings including the building A and the buildings C to F among the upper buildings A to F in which the communication failures occur and which are illustrated in FIG. 4 and supplying fuel to the emergency power generators accommodated in these buildings.

In a case where repair to the upper building A and the upper buildings C to F in which the communication failures occur is performed, as illustrated in FIG. 8, the communication failures of the upper building A and the upper buildings C to F, the communication failures of the lower buildings of the buildings A and B, the communication failures of the lower buildings of the buildings C and D, and the communication failures of the lower buildings of the buildings E and F, that is, the communication failures of all the lower building groups are recovered, and the lower buildings of the buildings A and B can continue to perform communication with one system. Thus, as illustrated in FIG. 8, the priority calculation unit 13 of the network management apparatus 10 according to the present embodiment calculates that communication is possible in all buildings other than the building B.

Thereby, the priority calculation unit 13 calculates that the number of influenced users, which is the number of users who are continuously influenced by the communication failures in a case where it is assumed that repair to the building A and the buildings C to F is performed, is the number of accommodatable users of the building B, that is, 30 persons.

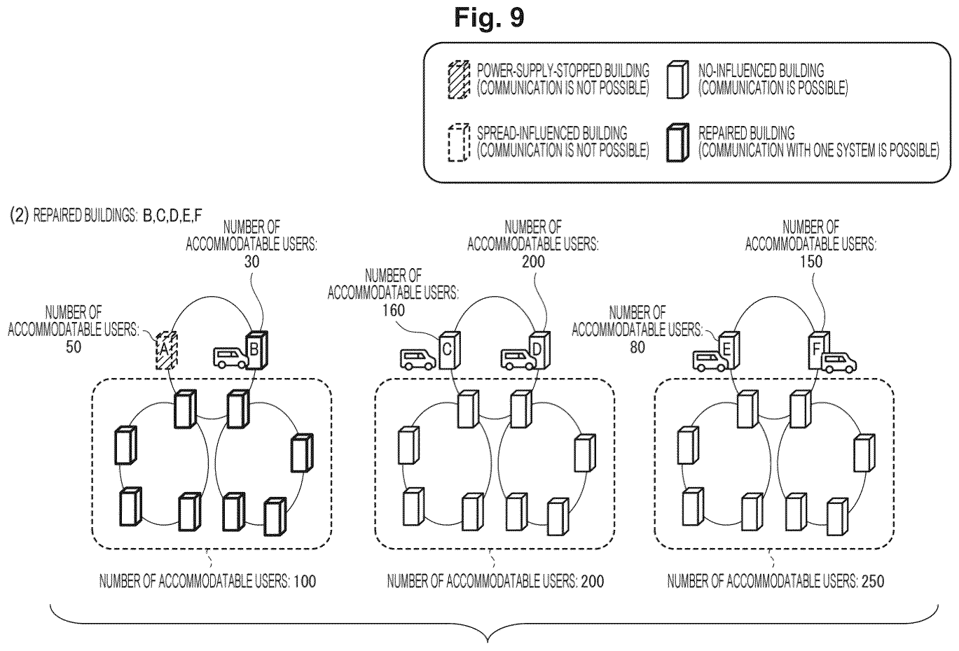

FIG. 9 is a diagram illustrating a third example of the number of influenced users calculated for each combination of buildings to be repaired by the priority calculation unit according to the embodiment of the present invention.

Here, it is assumed that each building is repaired by deploying the fuel delivery vehicles to five buildings including the buildings B to F among the upper buildings A to F in which the communication failures occur and which are illustrated in FIG. 4 and supplying fuel to the emergency power generators accommodated in these buildings.

In a case where repair to the upper buildings B to F in which the communication failures occur is performed, as illustrated in FIG. 9, the communication failures of the upper buildings B to F, the communication failures of the lower buildings of the buildings A and B, the communication failures of the lower buildings of the buildings C and D, and the communication failures of the lower buildings of the buildings E and F, that is, the communication failures of all the lower building groups are recovered, and the lower buildings of the buildings A and B can continue to perform communication with one system. Thus, as illustrated in FIG. 9, the priority calculation unit 13 of the network management apparatus 10 according to the present embodiment calculates that communication is possible in all buildings other than the building A.

Thereby, the priority calculation unit 13 calculates that the number of influenced users, which is the number of users who are continuously influenced by the communication failures in a case where it is assumed that repair to the buildings B to F is performed, is the number of accommodatable users of the building A, that is, 50 persons.

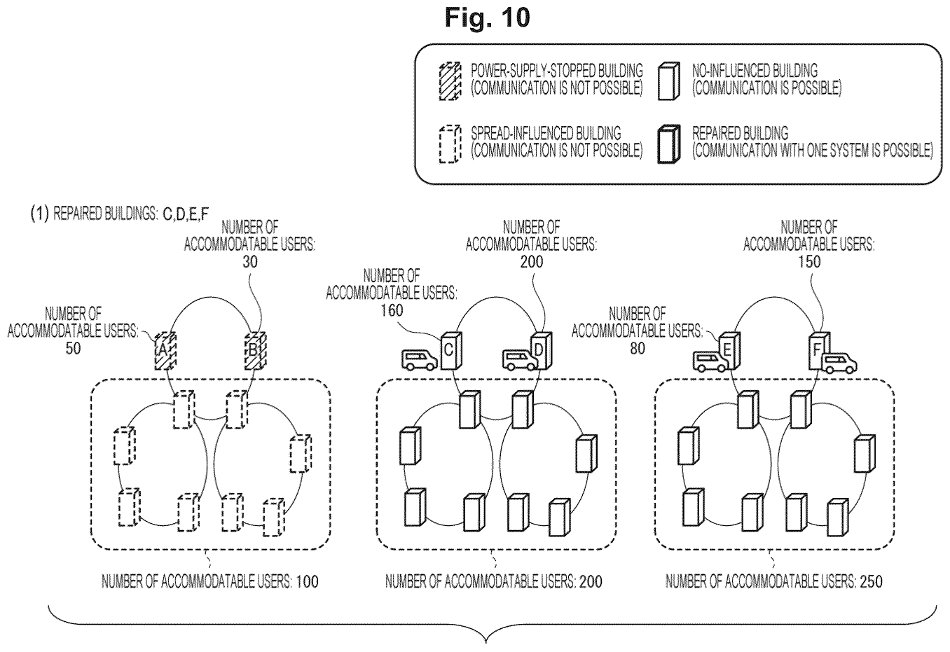

FIG. 10 is a diagram illustrating a fourth example of the number of influenced users calculated for each combination of buildings to be repaired by the priority calculation unit according to the embodiment of the present invention.

Here, it is assumed that each building is repaired by deploying the fuel delivery vehicles to four buildings including the buildings C to F among the upper buildings A to F in which the communication failures occur and which are illustrated in FIG. 4 and supplying fuel to the emergency power generators accommodated in these buildings.

In a case where repair to the upper buildings C to F in which the communication failures occur is performed, as illustrated in FIG. 10, the communication failures of the upper buildings C to F, the communication failures of the lower buildings of the buildings C and D, and the communication failures of the lower buildings of the buildings E and F are recovered. Thus, as illustrated in FIG. 10, the priority calculation unit 13 of the network management apparatus 10 according to the present embodiment calculates that communication is possible for the buildings other than the building A, the building B, and the lower buildings of the buildings A and B.

Thereby, the priority calculation unit 13 calculates that the number of influenced users, which is the number of users who are continuously influenced by the communication failures in a case where it is assumed that repair to the buildings C to F is performed, is a sum of the number of accommodatable users of the building A, the number of accommodatable users of the building B, and the number of accommodatable users of the lower buildings of the buildings A and B, that is, 180 persons.

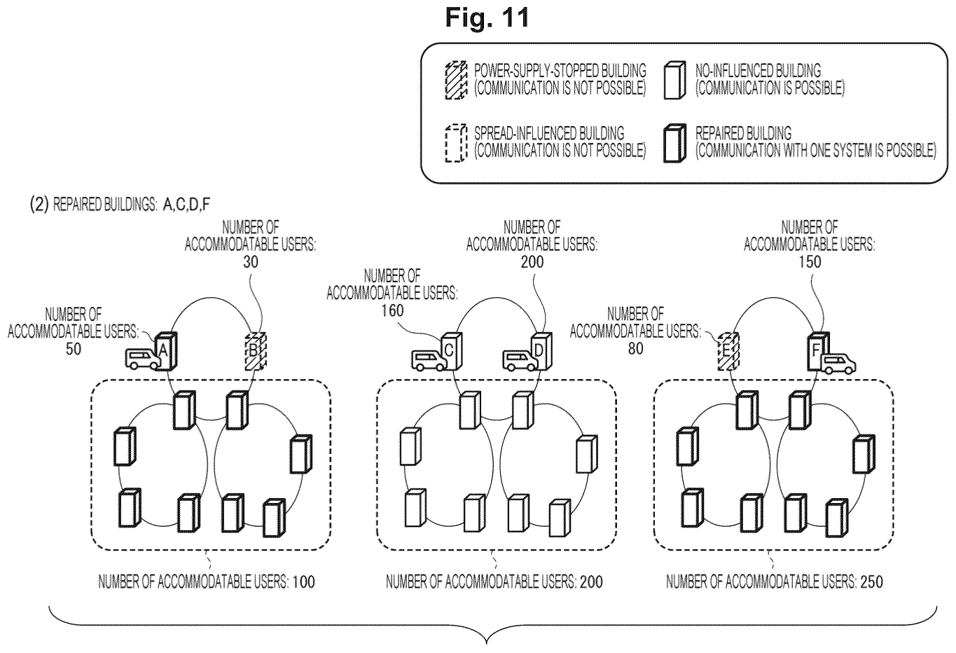

FIG. 11 is a diagram illustrating a fifth example of the number of influenced users calculated for each combination of buildings to be repaired by the priority calculation unit according to the embodiment of the present invention.

Here, it is assumed that each building is repaired by deploying the fuel delivery vehicles to four buildings including the building A, the building C, the building D, and the building F among the upper buildings A to F in which the communication failures occur and which are illustrated in FIG. 4 and supplying fuel to the emergency power generators accommodated in these buildings.

In a case where repair to the upper building A, the upper building C, the upper building D, and the upper building F in which the communication failures occur is performed, as illustrated in FIG. 11, the communication failures of the upper building A, the upper building C, the upper building D, and the upper building F, the communication failures of the lower buildings of the buildings A and B, the communication failures of the lower buildings of the buildings C and D, and the communication failures of the lower buildings of the buildings E and F, that is, the communication failures of all the lower building groups are recovered, and the lower buildings of the buildings A and B and the lower buildings of the buildings E and F can continue to perform communication with one system. Thus, as illustrated in FIG. 11, the priority calculation unit 13 of the network management apparatus 10 according to the present embodiment calculates that communication is possible for all buildings other than the building B and the building E.

Thereby, the priority calculation unit 13 calculates that the number of influenced users, which is the number of users who are continuously influenced by the communication failures in a case where it is assumed that repair to the building A, the building C, the building D, and the building F is performed, is a sum of the number of accommodatable users of the building B and the number of accommodatable users of the building E, that is, 110 persons. The calculated number of persons is the same as the number of persons illustrated in the description related to FIG. 6.

That is, in a case where the four buildings can be repaired, the number of influenced users after the repair is small in the combination of the buildings as repair destinations illustrated in FIG. 11 as compared with the number of influenced users after the repair by the combination of the buildings as repair destinations illustrated in FIG. 10. Thus, it can be seen that the combination illustrated in FIG. 11 is appropriate and has a high priority as the combination of the buildings as repair destinations.

Next, a deployment plan of the recovery work vehicles that is for recovery of the buildings to be repaired and is obtained by the deployment plan processing unit 14 according to the embodiment of the present invention will be described.

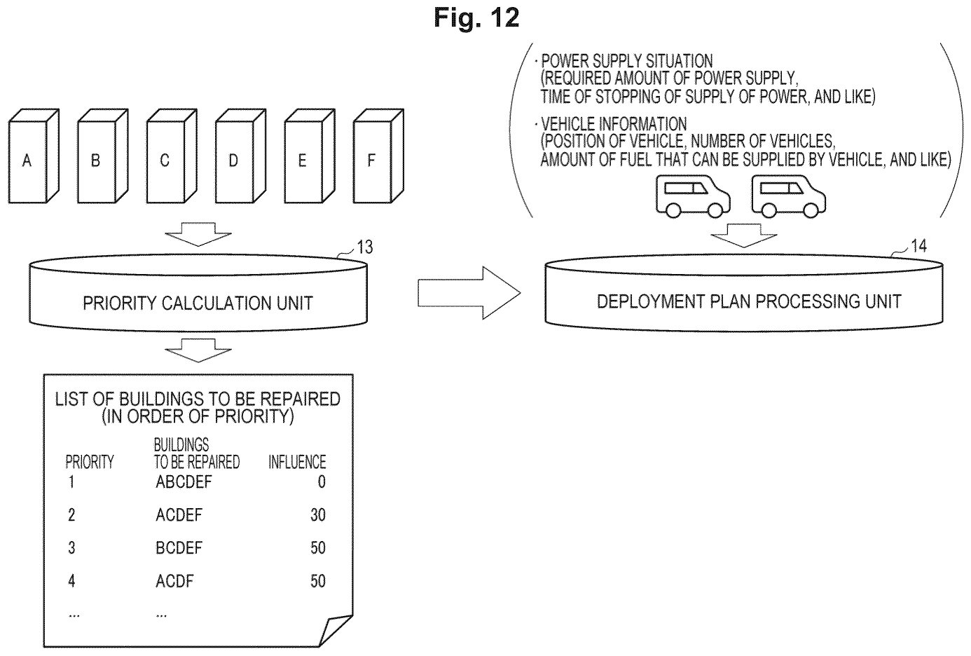

FIG. 12 is a diagram illustrating an example of generation of a deployment plan of the recovery work vehicles that is for recovery of the buildings to be repaired and is obtained by the deployment plan processing unit according to the embodiment of the present invention.

The priority calculation unit 13 obtains the number of influenced users after repair for all the patterns of the combinations of the buildings as repair destinations in a “repair building list” illustrated in FIG. 12, and calculates a priority for the combination of the buildings as repair destinations based on an influence degree that is the number of influenced users.

After the priority is calculated, the deployment plan processing unit 14 selects, as a pattern before selection, a pattern having a highest priority among the patterns of the combinations of the buildings as repair destinations, based on the power supply status and the fuel delivery vehicle information which are input by the user input unit 11.

In addition, the fuel delivery vehicle information includes, for example, a current position of a fuel delivery vehicle that is a possibility of the recovery work vehicle, the number of fuel delivery vehicles that can move to a building, an amount of fuel that can be carried and supplied by each fuel delivery vehicle, and the like.

The deployment plan processing unit 14 determines whether or not the fuel delivery vehicle can be actually deployed to each building as a repair destination according to the pattern, and searches for an optimal movement route of the fuel delivery vehicle to each building as a repair destination in a case where the fuel delivery vehicle can be deployed. The deployment plan output unit 15 outputs information indicating the route by displaying the information on a display device or the like.

In addition, in a case where it is determined that the fuel delivery vehicle cannot be actually deployed to each building related to the pattern selected as described above, the deployment plan processing unit 14 determines whether or not the fuel delivery vehicle can be actually deployed to each building as a repair destination according to the pattern having a next priority, and searches for an optimal route of the fuel delivery vehicle to each building as a repair destination in a case where the fuel delivery vehicle can be deployed.

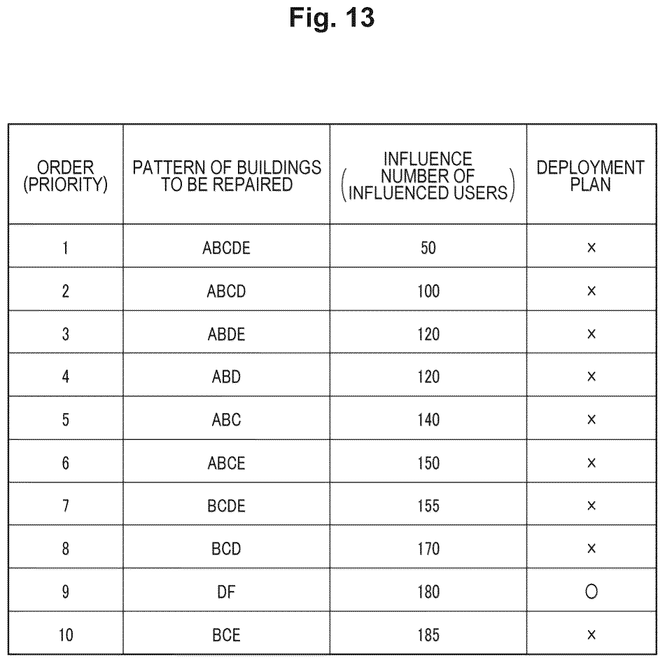

FIG. 13 is a diagram illustrating an example of a determination result as to whether or not the recovery work vehicle can be deployed by the deployment plan processing unit according to the embodiment of the present invention.

In the example illustrated in FIG. 13, in the patterns of the buildings to be repaired, from the pattern having a priority of “1” calculated as described above to the pattern having a low priority, it is determined whether or not the fuel delivery vehicle can be deployed to each building according to the pattern, and the determination result is reflected in a column of the deployment plan of a table illustrated in FIG. 13.

In the column of the deployment plan of the table illustrated in FIG. 13, “o” indicates that it is determined that the deployment is possible, and “x” in the column indicates that it is determined that the deployment is not possible.

In addition, in the table illustrated in FIG. 13, a row with “o” in the column of the deployment plan can be output by the deployment plan output unit 15.

As described above, the network management apparatus according to the embodiment of the present invention calculates an influence of a communication failure in a case where a communication failure occurs in a plurality of buildings in which communication facilities are accommodated and which correspond to upper layers of a network, the influence of the communication failure being an influence on other buildings corresponding to lower layers of the network by the occurred failure.

In addition, the network management apparatus calculates a priority of a possibility of the buildings in which the occurred failure is to be actually recovered among the buildings in which the failure occurs and which correspond to the upper layers, based on a degree of the communication failure continuously occurring in any building of the network under a condition in which the occurred failure and the calculated influence are applied and in a case where a condition in which it is assumed that the occurred failure is recovered in the building by recovery work for the communication facilities accommodated in the buildings in which the failure occurs and which correspond to the upper layers is applied.

Thereby, in a case where a communication failure occurs in the network redundant configuration, it is possible to appropriately determine a target to be recovered from the failure.

Further, the network management apparatus plans actual recovery work of the occurred failure based on a condition related to failure recovery work for the building corresponding to the calculated priority. Thereby, it is possible to appropriately determine a plan of communication failure recovery work.

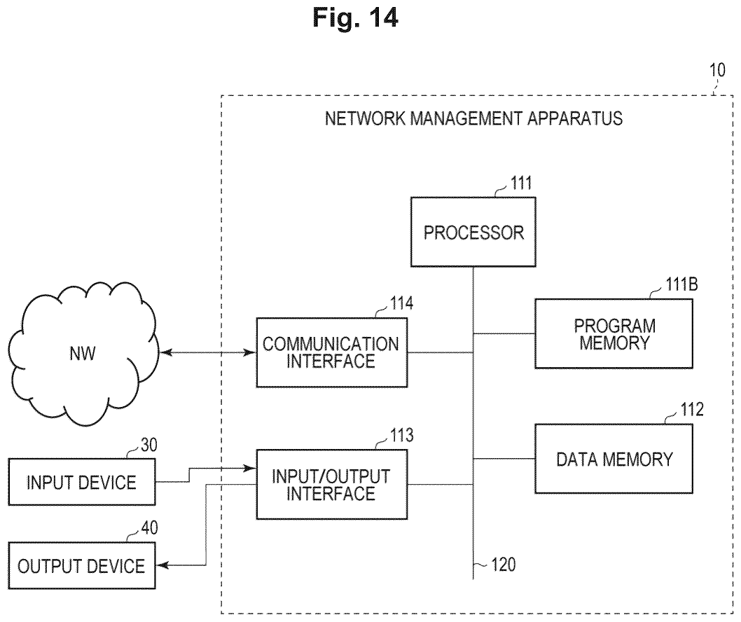

FIG. 14 is a block diagram illustrating an example of a hardware configuration of the network management apparatus according to the embodiment of the present invention.

In the example illustrated in FIG. 14, the network management apparatus 10 according to the embodiment is configured with, for example, a server computer or a personal computer, and includes a hardware processor 111A such as a CPU. In addition, a program memory 111B, a data memory 112, an input/output interface 113, and a communication interface 114 are connected to the hardware processor 111A via a bus 120.

The communication interface 114 includes, for example, one or more wireless communication interface units, and enables transmission and reception of information to and from a communication network NW. As the wireless interface, for example, an interface in which a low-power wireless data communication standard such as a wireless local area network (LAN) is adopted is used.

An input device 30 and an output device 40 that are attached to the network management apparatus 10 and are used by a user or the like are connected to the input/output interface 113.

The input/output interface 113 can perform processing of fetching operation data input by a user or the like via the input device 30 such as a keyboard, a touch panel, a touchpad, or a mouse, and outputting output data to the output device 40 including a display device using liquid crystal, organic electro-luminescence (EL), or the like and displaying the output data. Note that, as the input device 30 and the output device 40, a device built in the network management apparatus 10 may be used, or an input device and an output device of another information terminal that can communicate with the network management apparatus 10 via the network NW may be used.

The program memory 111B is used as a non-transitory tangible storage medium, for example, in a combination of non-volatile memory enabling writing and reading at any time, such as a hard disk drive (HDD) or a solid state drive (SSD), and non-volatile memory such as read only memory (ROM), and can store programs necessary for executing various control processing according to the embodiment.

The data memory 112 is used as a tangible storage medium, for example, in a combination of the non-volatile memory described above and volatile memory such as random access memory (RAM), and can be used to store various types of data or information acquired and created in the process of performing various types of processing.

The network management apparatus 10 according to the embodiment of the present invention can be configured as a data processing apparatus including the user input unit 11, the failure influence calculation unit 12, the priority calculation unit 13, the deployment plan processing unit 14, and the deployment plan output unit 15 which are illustrated in FIG. 1 as processing function units by software.

Information storage units used as work memories or the like by the respective units of the network management apparatus 10 can be formed using the data memory 112 illustrated in FIG. 14. Here, these configured storage areas are not essential configurations in the network management apparatus 10, and may be areas provided in, for example, an external storage medium such as a universal serial bus (USB) memory or a storage device such as a database server arranged in a cloud.

All the processing function units of the user input unit 11, the failure influence calculation unit 12, the priority calculation unit 13, the deployment plan processing unit 14, and the deployment plan output unit 15 can be achieved by causing the hardware processor 111A to read and execute the programs stored in the program memory 111B. Note that some or all of these processing function units may be implemented in other various forms including an integrated circuit such as an application specific integrated circuit (ASIC) or a field-programmable gate array (FPGA).

Further, the methods described in the embodiment can be stored in a recording medium such as a magnetic disk (Floppy (registered trademark) disk, hard disk, and the like), an optical disc (CD-ROM, DVD, MO, and the like), or a semiconductor memory (ROM, RAM, flash memory, and the like) as a program (software means) that can be executed by a computer, and can be distributed by being transmitted through a communication medium. Note that the programs stored on the medium side also include a setting program for configuring, in the computer, a software means (including not only an execution program but also tables and data structures) to be executed by the computer. The computer that implements the present device executes the above-described processing by reading the programs recorded in the recording medium, constructing the software means by the setting program as needed, and controlling the operation by the software means. Note that the recording medium described in the present specification is not limited to a recording medium for distribution, but includes a storage medium such as a magnetic disk or a semiconductor memory provided in the computer or in a device connected via a network.

Note that the present invention is not limited to the embodiments described above, and various modifications can be made in the implementation stage without departing from the scope of the invention. Each embodiment may be implemented in appropriate combination leading to combined effects. Furthermore, the embodiments described above include various inventions, and various inventions can be extracted by a combination selected from a plurality of disclosed components. For example, even if some components are eliminated from all the components described in the embodiment, in a case where the problem can be solved and the advantageous effects can be obtained, a configuration from which the components are eliminated can be extracted as an invention.

### REFERENCE SIGNS LIST

10 Network management apparatus
11 User input unit
12 Failure influence calculation unit
13 Priority calculation unit
14 Deployment plan processing unit
15 Deployment plan output unit

1. A network management apparatus comprising:
failure influence calculation circuitry that calculates, in a case where a communication failure occurs in a plurality of buildings in which communication facilities are accommodated and which correspond to upper layers of a network, an influence of the communication failure, the influence being an influence on other buildings corresponding to lower layers of the network by the occurred failure; and
priority calculation circuitry that calculates a priority of a possibility of the buildings in which the occurred failure is to be actually recovered among the buildings in which the failure occurs and which correspond to the upper layers, based on a degree of the communication failure continuously occurring in any building of the network under a condition in which the occurred failure and the influence calculated by the failure influence calculation circuitry are applied and in a case where a condition in which it is assumed that the occurred failure is recovered in the buildings by recovery work for the communication facilities accommodated in the buildings in which the failure occurs and which correspond to the upper layers is applied.

2. The network management apparatus according to claim 1, further comprising:
plan processing circuitry that plans actual recovery work of the occurred failure based on a condition related to the failure recovery work for the building corresponding to the priority calculated by the priority calculation circuitry.

3. The network management apparatus according to claim 1,
wherein the failure influence calculation circuitry calculates, in a case where the failure occurs due to stopping of supply of power to the communication facilities accommodated in the plurality of buildings corresponding to the upper layers, an influence of the communication failure, the influence being an influence on other buildings corresponding to the lower layers by the occurred failure, and
wherein the priority calculation circuitry calculates the priority of a possibility of the buildings in which supply of power is to be actually recovered among the buildings in which the failure occurs and which correspond to the upper layers, based on a degree of the communication failure continuously occurring in any building of the plurality of buildings in the network under a condition in which the occurred failure and the influence calculated by the failure influence calculation circuitry are applied and in a case where a condition in which it is assumed that supply of power to the communication facilities accommodated in the buildings in which the failure occurs and which correspond to the upper layers is recovered is applied.

4. The network management apparatus according to claim 2,
wherein the plan processing circuitry plans information indicating a vehicle to be actually deployed to the building and a movement route of the vehicle to the building, in order of the buildings having a high priority calculated by the priority calculation circuitry, based on information related to the failure of the building and information related to a possibility of the vehicle to be deployed for recovery work of the failure for the building.

5. A network management method, comprising:
calculating, in a case where a communication failure occurs in a plurality of buildings in which communication facilities are accommodated and which correspond to upper layers of a network, an influence of the communication failure, the influence being an influence on other buildings corresponding to lower layers of the network by the occurred failure; and
calculating a priority of a possibility of the buildings in which the occurred failure is to be actually recovered among the buildings in which the failure occurs and which correspond to the upper layers, based on a degree of the communication failure continuously occurring in any building of the network under a condition in which the occurred failure and the calculated influence are applied and in a case where a condition in which it is assumed that the occurred failure is recovered in the buildings by recovery work for the communication facilities accommodated in the buildings in which the failure occurs and which correspond to the upper layers is applied.

6. The network management method according to claim 5, further comprising:
planning actual recovery work of the occurred failure based on a condition related to the failure recovery work for the building corresponding to the calculated priority.

7. The network management method according to claim 5,
wherein the calculating the influence of the failure includes calculating, in a case where the failure occurs due to stopping of supply of power to the communication facilities accommodated in the plurality of buildings corresponding to the upper layers, the influence of the communication failure, the influence being an influence on other buildings corresponding to the lower layers by the occurred failure, and
wherein the calculating the priority includes calculating the priority of a possibility of the buildings in which supply of power is to be actually recovered among the buildings in which the failure occurs and which correspond to the upper layers, based on a degree of the communication failure continuously occurring in any building of the plurality of buildings in the network under a condition in which the occurred failure and the calculated influence are applied and in a case where a condition in which it is assumed that supply of power to the communication facilities accommodated in the buildings in which the failure occurs and which correspond to the upper layers is recovered is applied.

8. A non-transitory computer readable medium storing a network management processing program for causing a processor to function as each of the circuitries of the network management apparatus according to claim 1.

9. A non-transitory computer readable medium storing a network management processing program for causing a processor to perform the network management method of claim 5.
